(19) United States
(12) Patent Application Publication
(10) Pub. No.: US 2024/0164599 A1
(43) Pub. Date: May 23, 2024

(54) TOILET SEAT CLEANING APPARATUS

(71) Applicant: TODOGLOBAL CO., LTD., Gyeonggi-do (KR)

(72) Inventor: Myeong Oke LEE, Gwangju-si (KR)

(21) Appl. No.: 18/282,713

(22) PCT Filed: Mar. 18, 2022
(86) PCT No.: PCT/KR2022/003798

§ 371 Date: Sep. 18, 2023

(30) Foreign Application Priority Data
Mar. 18, 2021 (KR) 10-2021-0035479

(51) Int. Cl. A47K 13/30; B08B 3/02

(52) U.S. Cl. CPC A47K 13/302; B08B 3/02

(57) ABSTRACT

A toilet seat cleaning apparatus includes: a seat part including a lower surface facing an upper surface of a ceramic toilet bowl and an upper surface provided to enable a user's lower body to be in contact therewith; a cover part covering or opening the upper surface of the seat part; a drain part provided under the seat part and guiding cleaning water flowing outside the outline of the seat part to a discharge hole in the ceramic toilet bowl; and a body part to which one side of the cover part is rotatably coupled. In a state where the cover part is opened, the other side of the seat part protrudes more forward than the other side of the drain part. In a state where the cover part is closed, the other side of the drain part protrudes more forward than the other side of the seat part.

### TECHNICAL FIELD

An embodiment of the present invention relates to a toilet seat cleaning apparatus.

### BACKGROUND ART

A toilet, which is a sanitary fixture collecting and treating human urine and feces, includes a toilet bowl, a seat, a cover, etc.

In the case of an existing toilet, if a variety of contaminants such as urine, feces, and the like are stained on a toilet seat, a user who uses the toilet next time cleans the toilet seat or places a tissue, vinyl, paper, or the like on the toilet seat, and after that, he or she uses the toilet, thereby causing many inconveniences.

One of conventional toilet seat cleaning apparatuses is disclosed in Patent Literature 1 (Korean Patent No. 10-2072936) by the same inventor as in the present invention. The apparatus as disclosed in Patent Literature 1 includes a cover body for covering a discharge hole, together with a seat, a cleaning liquid spray part disposed on the cover body to spray a cleaning liquid toward the seat, and a gas spray part for spraying a gas toward the seat to remove the cleaning liquid existing on the seat.

The above-mentioned background art is retained by the present inventor to derive the present invention or information acquired in a process of deriving the present invention, and accordingly, it cannot be necessarily known technology published to the general public before filing of the present invention.

### DISCLOSURE

### Technical Problem

Accordingly, it is an object of the present invention to provide a toilet seat cleaning apparatus that is capable of preventing the area around a toilet from being contaminated due to a cleaning liquid supplied to a seat part to clean the seat part, while minimizing a user's unpleasant feeling when he or she uses the toilet.

### Technical Solution

A toilet seat cleaning apparatus according to an exemplary embodiment of the present invention may include: a seat part having a lower seat facing top of a ceramic toilet bowl and an upper seat with which a user's lower body comes into contact; a cover part for covering or opening the upper seat of the seat part; a drain part provided under the seat part and inducing a cleaning liquid flowing to the outside of the outer periphery of the seat part to flow to a discharge hole in the ceramic toilet bowl; and a body part to which one side of the cover part is rotatably coupled, wherein in a state where the cover part is opened, the other side of the seat part protrudes more forward than the other side of the drain part, and in a state where the cover part is closed, the other side of the drain part protrudes more forward than the other side of the seat part.

In this case, one side of the seat part may be coupled to the body part, whereby if the other side of the cover part moves up, the seat part moves forward to allow the other side thereof to protrude more forward than the other side of the drain part, and if the other side of the cover part moves down, the seat part moves backward to allow the other side of the drain part to protrude more forward than the other side of the seat part.

Further, the drain part may include a first unit and a second unit, whereby if the other side of the cover part moves up, a distance between the first unit and the second unit becomes narrow, and if the other side of the cover part moves down, the distance between the first unit and the second unit becomes wide.

Furthermore, the drain part may include a first unit and a second unit, whereby if the seat part moves forward, a distance between the first unit and the second unit becomes narrow, and if the seat part moves backward, the distance between the first unit and the second unit becomes wide.

Besides, the toilet seat cleaning apparatus may further include: first connectors coupled to the body part in such a way as to be rotatable around a first rotary shaft, while being coupled to one side of the cover part; and second connectors coupled to the body part in such a way as to be movable forward or backward on the body part, while being coupled to one side of the seat part, wherein if the other side of the cover part moves up, the first connectors rotate in a first direction to allow a first protrusion of each first connector to push the corresponding second connector forward, and if the other side of the cover part moves down, the first connectors rotate in a second direction to allow a second protrusion of each first connector to pull the corresponding second connector backward.

In addition, the drain part may further include: a first guide wing located on the first unit; and a first converter to which the first guide wing is slidably coupled, whereby in a state where the first converter is coupled to the underside of the seat part, if the seat part moves forward, the first converter moves forward to allow the first unit to move in a direction close to the second unit, and if the seat part moves backward, the first converter moves backward to allow the first unit to move in a direction distant from the second unit.

Furthermore, the drain part may further include: a second guide wing located on the second unit; and a second converter to which the second guide wing is slidably coupled, whereby in a state where the second converter is coupled to the underside of the seat part, if the seat part moves forward, the second converter moves forward to allow the second unit to move in a direction close to the first unit, and if the seat part moves backward, the second converter moves backward to allow the second unit to move in a direction distant from the first unit.

Further, the drain part may further include: a first shaft located on one end of the first unit; and a second shaft pin located on one end of the second unit, the first shaft pin and the second shaft pip being rotatably coupled to each other, whereby if the seat part moves forward, the first unit and the second unit rotate in a direction where a distance between the first guide wing and the second guide wing becomes narrow, and if the seat part moves backward, the first unit and the second unit rotate in a direction where the distance between the first guide wing and the second guide wing becomes wide.

The toilet seat cleaning apparatus may further include a cleaning liquid spray module and a wiper located disposed between the cover part and the seat part, the cleaning liquid spray module being adapted to spray the cleaning liquid on the upper seat of the seat part and the wiper being adapted to move in a state of being brought into contact with the upper seat of the seat part to remove the cleaning liquid remaining on the surface of the seat part.

Further, the seat part may include connecting arms located on the rear side thereof, one side of each connecting arm being coupled to the body part and the other side thereof being coupled to the seat part, whereby top of each connecting arm is lower than the upper seat of the seat part on a portion where the other side of the connecting arm is connected to the seat part so that a step is formed therebetween, and the wiper passes through top of each connecting arm, while coming into contact with at least a portion of the outer surface of the seat part.

### Advantageous Effects

According to the embodiment of the present invention, the toilet seat cleaning apparatus can prevent the area around the toilet from being contaminated due to the cleaning liquid for the seat part, while minimizing the user's unpleasant feeling when he or she uses the toilet.

### BRIEF DESCRIPTION OF DRAWINGS

FIG. 1 is a schematic perspective view showing a toilet seat cleaning apparatus according to an embodiment of the present invention.

FIG. 2 is a perspective view showing an operating principle of the toilet seat cleaning apparatus according to the embodiment of the present invention.

FIG. 3 is an exploded perspective view showing main parts of the toilet seat cleaning apparatus according to the embodiment of the present invention.

FIG. 4 is an exploded perspective view showing a state where a cover part is opened in the toilet seat cleaning apparatus according to the embodiment of the present invention

FIG. 5 is a perspective view showing an operating principle of a seat part of the toilet seat cleaning apparatus according to the embodiment of the present invention.

FIG. 6 is a perspective view showing the operating principle of the seat part of the toilet seat cleaning apparatus according to the embodiment of the present invention.

FIG. 7 is a sectional view showing then operating principle of the seat part of the toilet seat cleaning apparatus according to the embodiment of the present invention.

FIG. 8 is an exploded perspective view showing the seat part and a drain part of the toilet seat cleaning apparatus according to the embodiment of the present invention.

FIG. 9 is a schematic top view showing the drain part of the toilet seat cleaning apparatus according to the embodiment of the present invention.

FIG. 10 is an exploded top view showing the drain part of FIG. 9.

FIG. 11 is an exploded perspective view showing the drain part of FIG. 9.

FIG. 12 is a sectional view showing the main parts of FIG. 9.

FIG. 13 is a view showing the toilet seat cleaning apparatus according to the embodiment of the present invention.

FIG. 14 is a view showing the toilet seat cleaning apparatus according to the embodiment of the present invention.

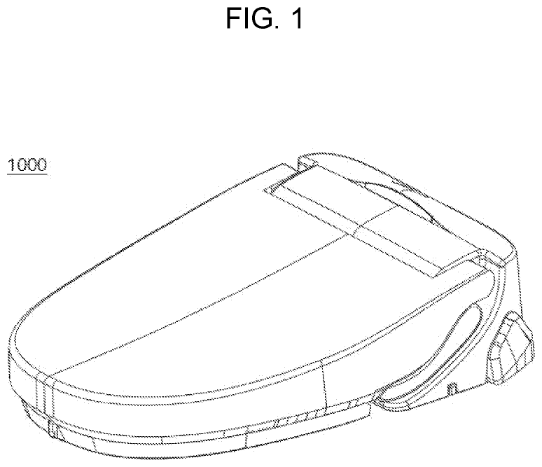

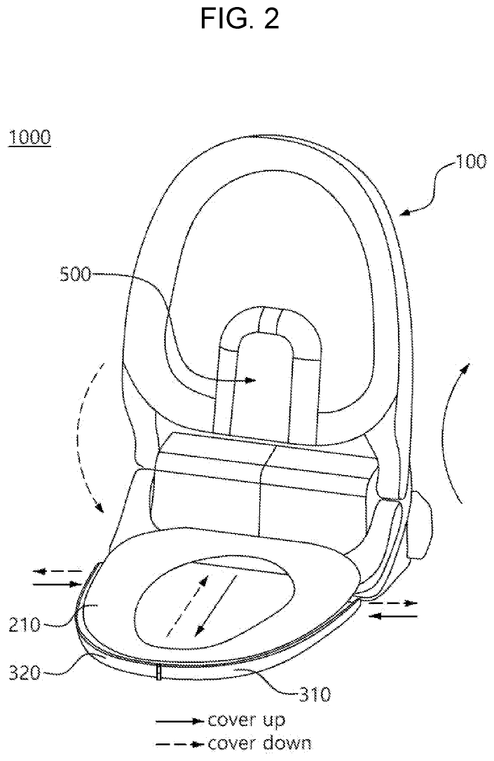

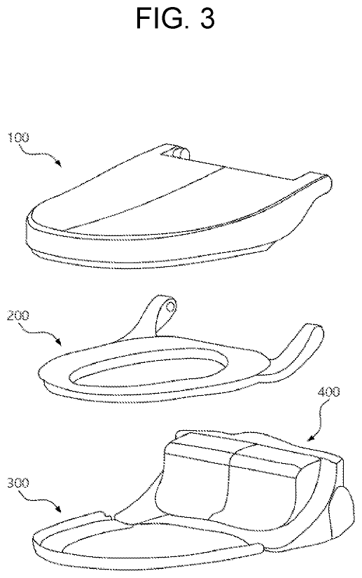

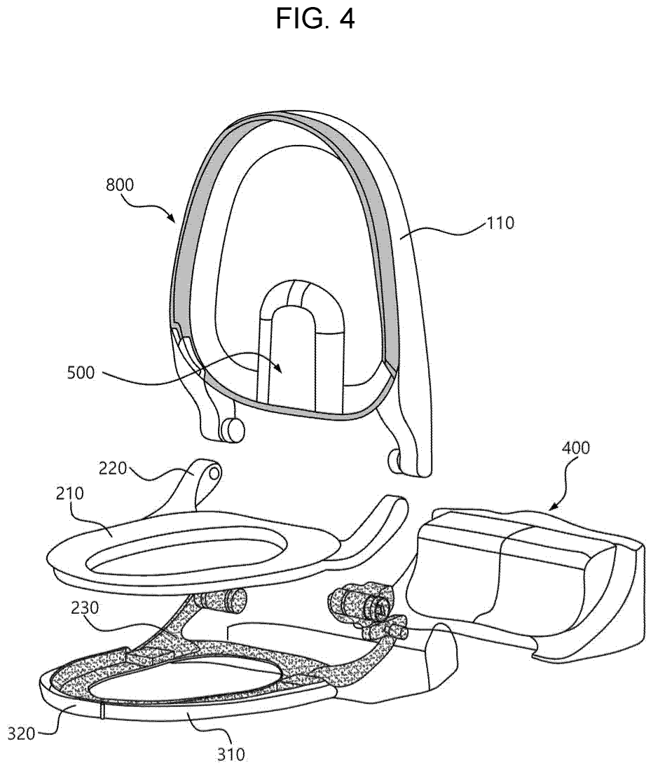

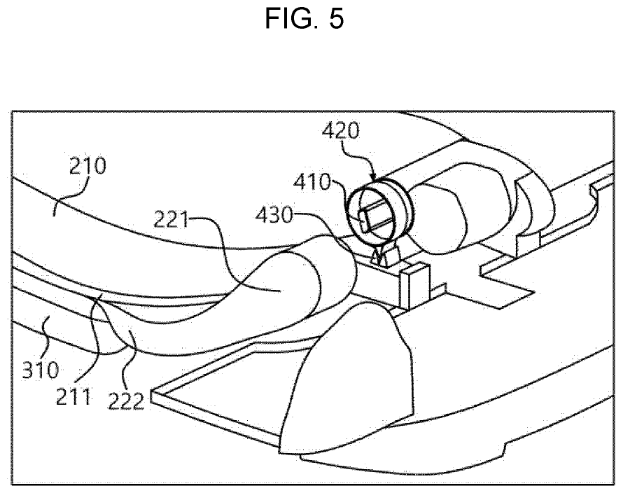

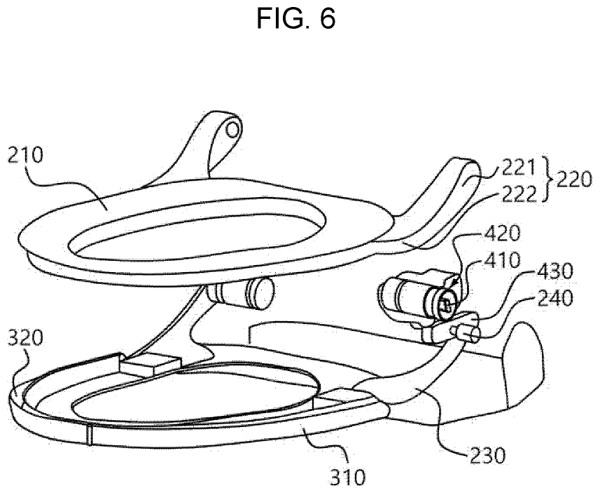

### BEST MODE FOR INVENTION

Objects, characteristics and advantages of the present invention will be more clearly understood from the detailed description as will be described below and the attached drawings. Before the present invention is disclosed and described, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. In the description, the same reference numerals will be used to describe the same components

Terms used in the specification are used to only describe specific exemplary embodiments and are not intended to restrict the present invention. An expression referencing a singular value additionally refers to a corresponding expression of the plural number, unless explicitly limited otherwise by the context. In this application, terms, such as “comprise”, and/or “comprising are intended to designate those parts, steps, operations, and/or elements which are described in the specification that exist, and it should be understood that they do not preclude the possibility of the existence or possible addition of one or more additional parts, steps, operations, and/or elements.

Hereinafter, an explanation of a configuration and an operating effect of the present invention will be given in detail with reference to the attached drawings.

A toilet seat cleaning apparatus 1000 according to an embodiment of the present invention includes a cover part 100, a seat part 200, a drain part 300, and a body part 400.

According to the embodiment of the present invention, the cover part 100 serves to cover or open a ceramic toilet bowl and the seat part 200. One side of the cover part 100 is coupled to the body part 400, and accordingly, the cover part 100 is rotatable around a first rotary shaft passing through a point on the body part 400. If the other side of the cover part 100 moves up, the ceramic toilet bowl and the seat part 200 are opened, and contrarily, if the other side of the cover part 100 moves down, the ceramic toilet bowl and the seat part 200 are covered with the cover part 100. According to the embodiment of the present invention, the body part 400 has a driving shaft 410 located on the same horizontal line as the first rotary shaft, and one end of the cover part 100 is connected to the driving shaft 410, so that the cover part 100 is rotatable. Further, a rotary force generated from a motor or the like is applied to the driving shaft 410 to allow the cover part 100 to rotate in a clockwise or counterclockwise direction, and accordingly, the other side of the cover part 100 moves up or down.

According to the embodiment of the present invention, a cleaning liquid spray module 800 and a wiper module 500 are provided under the cover part 100.

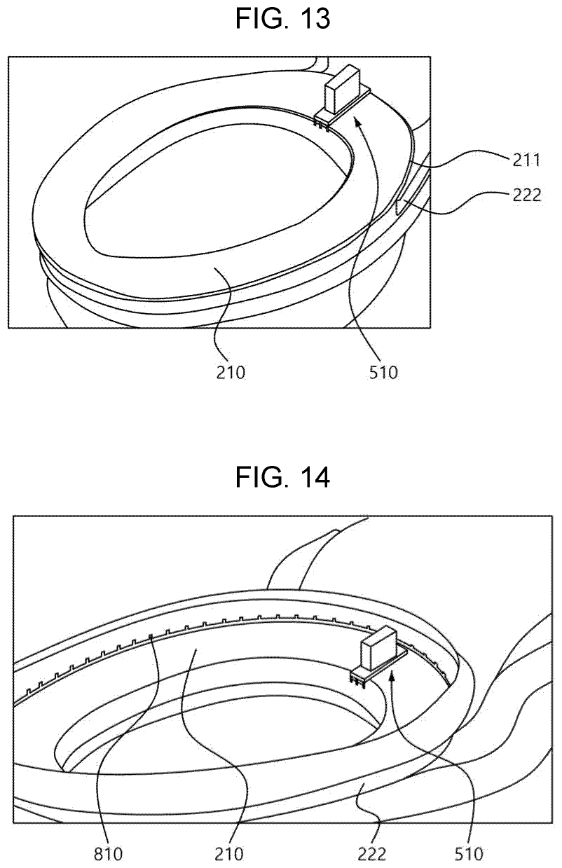

According to the embodiment of the present invention, the cleaning liquid spray module 800 includes cleaning liquid spray units 810 as shown in FIG. 14, and the cleaning liquid spray units 810 serve to spray a cleaning liquid on an upper seat 210 of the seat part 200.

According to the embodiment of the present invention, the wiper module 500 includes a wiper unit 510 as shown in FIGS. 13 and 14. The wiper unit 510 is hidden inside the wiper module 500 and protrudes outward if necessary, and a wiper disposed in the wiper unit 510 moves in a state of being brought into contact with the upper seat 210 of the seat part 200 and thus removes the cleaning liquid remaining on the upper seat 210.

According to the embodiment of the present invention, the seat part 200 is disposed on top of the ceramic toilet bowl and serves to prevent a user's body from coming into contact with the ceramic toilet bowl in a process where he or she sits on the seat part 200 for his or her urination or defecation. According to the embodiment of the present invention, the seat part 200 includes the upper seat 210, a lower seat 230, and connecting arms 220. The upper seat 210 is provided to allow the user's lower body to be in contact therewith, and the lower seat 230 faces top of the ceramic toilet seat. Further, one side 221 of each connecting arm 220 is coupled to the body part 400, and the other side 222 to the seat part 200. In this case, top of each connecting arm 220 is lower than top of the seat part 200 on a portion where the other side 222 of the connecting arm 220 is connected to the seat part 200, thereby providing a step therebetween, and the wiper passes through top of each connecting arm 220, while coming into contact with at least a portion of the outer surface of the seat part 200. Further, the wiper comes into close contact with top of the upper seat 210 and a side peripheral surface 211 (See FIG. 13) of the upper seat 210 and thus removes the cleaning liquid therefrom. In this case, the wiper can move smoothly through the formation of the step between the seat part 200 and each connecting arm 220.

According to the embodiment of the present invention, the drain part 300 is disposed under the seat part 200 and serves to collect the cleaning liquid flowing to the outside from the outer periphery of the seat part 200. Further, the drain part 300 induces the collected cleaning liquid to a discharge hole formed inside the ceramic toilet bowl.

According to the embodiment of the present invention, the drain part 300 is converted into a first state where at least a portion of the drain part 300 is located more outward than the outer periphery of the seat part 200 or into a second state where the at least a portion of the drain part 300 is not located more outward than the outer periphery of the seat part 200. In a state where the cover part 100 is closed, the drain part 300 is converted into the first state, and contrarily, in a state where the cover part 100 is opened, the drain part 300 is converted into the second state. In a process where the cleaning liquid is provided to the upper seat 210 and the cleaning process is thus performed in the state where the cover part 100 is closed, accordingly, the cleaning liquid flowing to the outer periphery of the seat part 200 is collected by the drain part 300, so that while the seat part 200 is being cleaned, the area around the toilet can be prevented from being contaminated. In the state where the cover part 100 is opened, contrarily, the drain part 300 is converted into the second state where the at least a portion of the drain part 300 is not located more outward than the outer periphery of the seat part 200, so that the user performs his or her urination or defecation, without any recognition of the existence of the drain part 300, and a danger in which the user's legs come into contact with the drain part 300 is remarkably suppressed.

According to the embodiment of the present invention, the seat part 200 moves forward and backward according to the upward and downward movements of the other side of the cover part 100. That is, if the other side of the cover part 100 moves up, the seat part 200 moves forward, and contrarily, if the other side of the cover part 100 moves down, the seat part 200 moves backward. According to the embodiment of the present invention, the upward and downward movements of the other side of the cover part 100 are inputted to the body part 400 by means of first connectors 420 connected to one side of the cover part 100, and further, the forward and backward movements of the seat part 200 are inputted to the body part 400 by means of second connectors 430 coupled to the connecting arms 220.

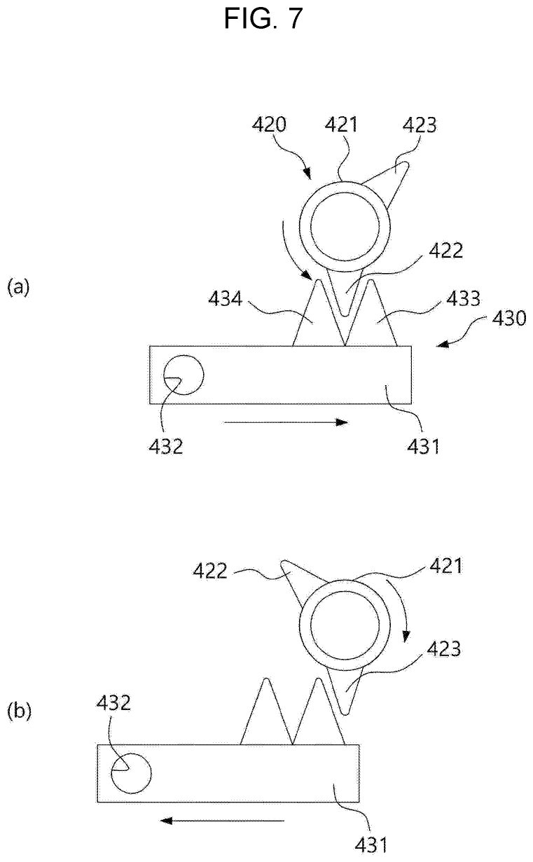

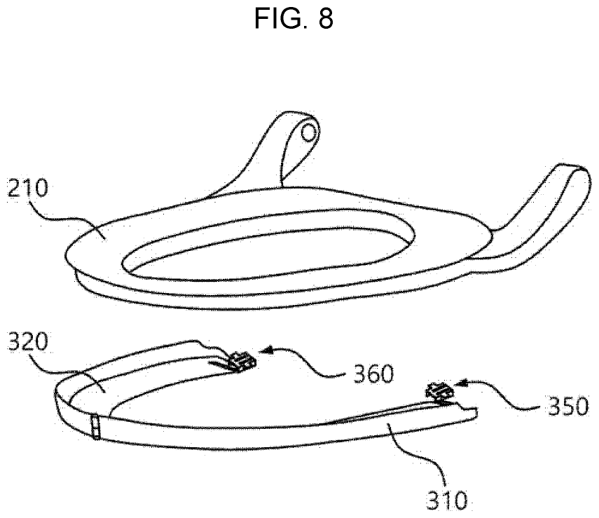

According to the embodiment of the present invention, each first connector 420 includes a first connector body 421 and protrusions. Referring to FIG. 7, a first protrusion 423 and a second protrusion 422 protrude from the outer peripheral surface of the first connector body 421 having the shape of a ring in a circumferential direction of the first connector body 421.

According to the embodiment of the present invention, each second connector 430 includes a second connector body 431 and protrusions. Referring to FIG. 7, a first protrusion 433 and a second protrusion 434 protrude upward from the second connector body 431 having the shape of a bar.

According to the embodiment of the present invention, each second connector 430 has a concave groove 432 adapted to insert a connection pin 240 thereinto. Each connecting arm 220 of the seat part 200 is coupled to the connection pin 240. Further, the connection pin 240 is coupled to the concave groove 432 in such a way as to be rotatable inside the concave groove 432. Next, the connecting arm 220 is coupled to the connection pin 240. Accordingly, the connecting arms 220, the upper seat 210, and the lower seat 230 are rotatable around the concave grooves 432.

According to the embodiment of the present invention, if the other side of the cover part 100 moves down, as shown in FIG. 7a, the first connectors 420 rotate in the counterclockwise direction, and accordingly, the second protrusions 422 push the first protrusions 433 backward, so that the second connectors 430 move backward to cause the seat part 200 to move backward.

According to the embodiment of the present invention, if the other side of the cover part 100 moves up, as shown in FIG. 7b, the first connectors 420 rotate in the clockwise direction, and accordingly, the first protrusions 423 push the first protrusions 433 forward, so that the second connectors 430 move forward to cause the seat part 200 to move forward.

According to the embodiment of the present invention, intervals between the start time points of the forward and backward movements of the second connectors 430 and the time points of the rotations of the cover part 100 may be generated because of internal angles between the first protrusions 423 and the second protrusions 422. That is, even though the other side of the cover part 100 starts to move up in a state where the seat part 200 is covered with the cover part 100, the second connectors 430 do not move forward until the first protrusions 423 come into contact with the first protrusions 433. Further, even though the other side of the cover part 100 starts to move down in a state where the cover part 100 is opened, the second connectors 430 do not move backward until the second protrusions 422 come into contact with the first protrusions 433. If the seat part 200 moves at the same time when the cover part 100 starts to move, the user may be suddenly surprised, and if the user's force is applied to move the cover part 100, a relatively strong force is needed at the time when the cover part 100 starts to move, so that the user does not feel any conveniences in using the toilet. Further, even in the case where the connection pins operate with the power of a motor, the seat part 200 starts to move after the cover part 100 somewhat rotates, so that initial loads applied to the connection pins are reduced and the rotation of the cover part 100 and the linear movement of the seat part 200 are performed with the help of the weight or acceleration of the cover part 100.

According to the embodiment of the present invention, the drain part 300 includes a first unit 310 and a second unit 320. The drain part 300 is configured to allow a distance between the first unit 310 and the second unit 320 to be varied according to the forward and backward movements of the seat part 200. If the seat part 200 moves forward, that is, the distance between the first unit 310 and the second unit 320 becomes narrow, and contrarily, if the seat part 200 moves backward, the distance between the first unit 310 and the second unit 320 becomes wide.

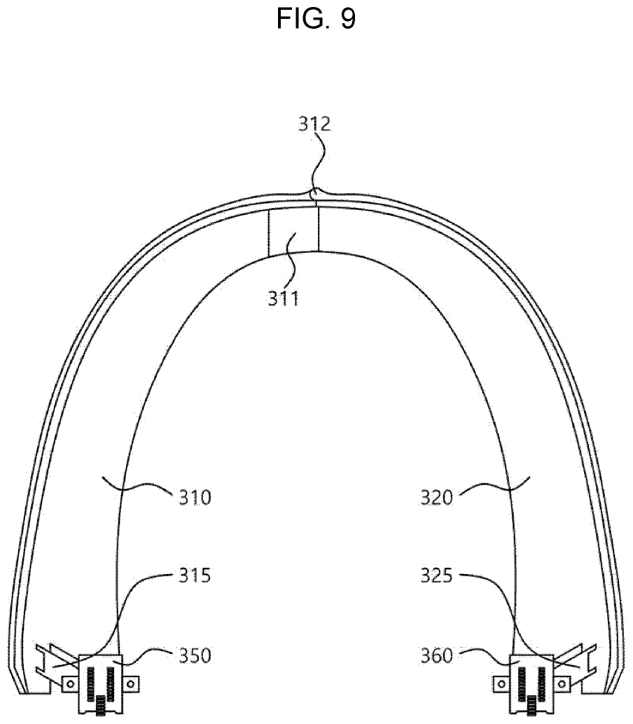

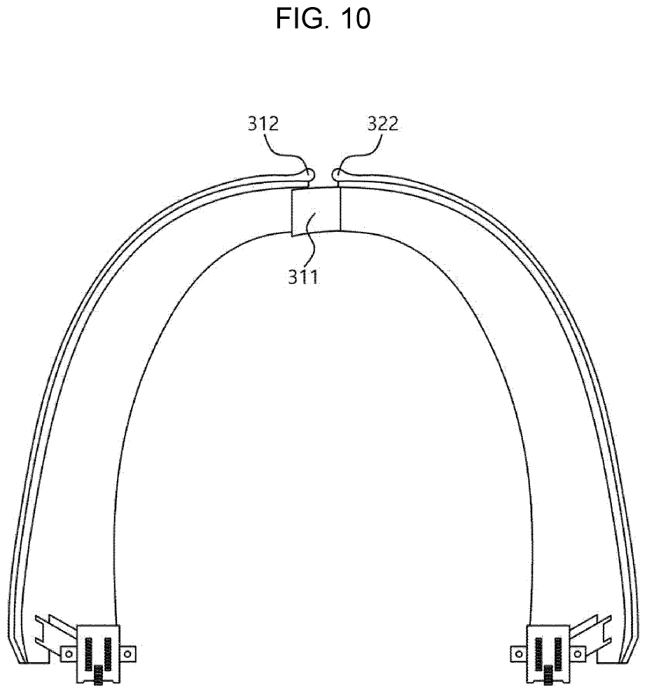

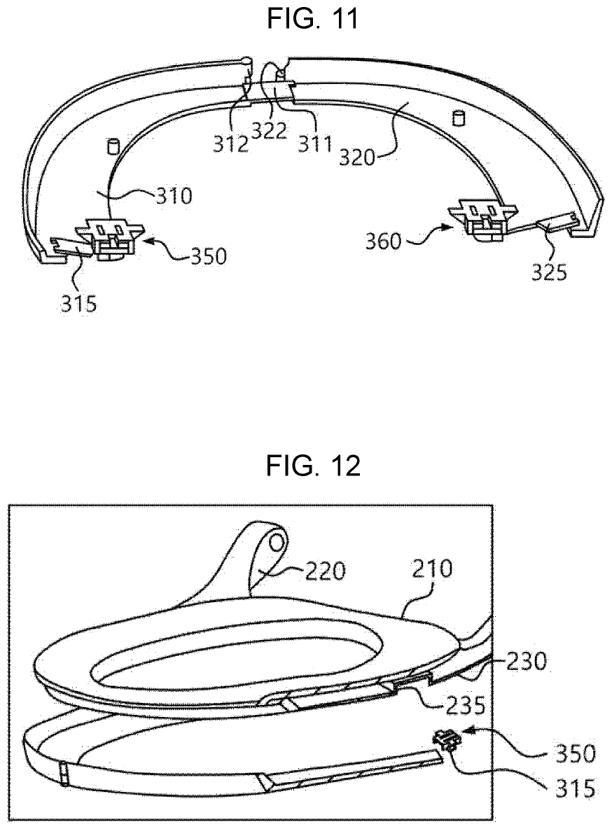

According to the embodiment of the present invention, the drain part 300 further includes a first converter 350 and a first guide wing 315. The first guide wing 315 is located on the rear side of the first unit 310 and slidable on the first converter 350. As the first converter 350 moves forward, further, the first guide wing 315 is inserted more deeply into the first converter 350, and contrarily, as the first converter 350 moves backward, the depth of the first guide wing 315 inserted into the first converter 350 becomes short. For example, as shown in FIGS. 9 to 11, the first guide wing 315 is slant toward the rear side of the first unit 310 as it goes from the outer edge of the first unit 310 toward the second unit 320.

According to the embodiment of the present invention, the drain part 300 further includes a second converter 360 and a second guide wing 325. The second guide wing 325 is located on the rear side of the second unit 320 and slidable on the second converter 360. As the second converter 350 moves forward, further, the second guide wing 325 is inserted more deeply into the second converter 360, and contrarily, as the second converter 360 moves backward, the depth of the second guide wing 325 inserted into the second converter 360 becomes short. For example, as shown in FIGS. 9 to 11, the second guide wing 325 is slant toward the rear side of the second unit 320 as it goes from the outer edge of the second unit 320 toward the first unit 310.

According to the embodiment of the present invention, the first converter 350 and the second converter 360 are locked onto the seat part 200, so that if the seat part 200 moves forward, the first converter 350 and the second converter 360 move forward, and if the seat part 200 moves backward, the first converter 350 and the second converter 360 move backward. According to the embodiment of the present invention, accommodation grooves 235 are formed on the lower plate 230, and accordingly, at least portions of the first converter 350 and the second converter 360 are inserted into the accommodation grooves 235.

According to the embodiment of the present invention, the drain part 300 has a first shaft pin 312 located on one end of the first unit 310 and a second shaft pin 322 located on one end of the second unit 320. The first shaft pin 312 and the second shaft pip 322 are rotatably coupled to each other. Accordingly, the first unit 310 and the second unit 320 rotate around the first shaft pin 312 and the second shaft pip 322 in a direction where the other end of the first unit 310 and the other end of the second unit 320 become narrow or wide with respect to each other. Further, if the seat part 200 moves forward, the first unit 310 and the second unit 320 rotate in a direction where a distance between the first guide wing 315 and the second guide wing 325 becomes narrow, and contrarily, if the seat part 200 moves backward, the first unit 310 and the second unit 320 rotate in a direction where the distance between the first guide wing 315 and the second guide wing 325 becomes wide.

According to the embodiment of the present invention, a guide cover 311 is located on one end of the first unit 310. The guide cover 311 serves to prevent the cleaning liquid from leaking to the gap between the first unit 310 and the second unit 320 even in the case where the distance between the first unit 310 and the second unit 320 becomes wide.

As described above, the representative embodiments of the present invention have been explained in detail. The toilet seat cleaning apparatus having the above-mentioned configuration can prevent the area around the toilet from being contaminated due to the cleaning liquid for the seat part 200, while minimizing the user's unpleasant feeling when he or she uses the toilet. In specific, the drain part 300 adapted to prevent the cleaning liquid from leaking to the outside moves according to the opening and closing operations of the cover part 100, so that if the cover part 100 is opened by the user for his or her urination or defecation, the toilet seat has a similar shape to a general toilet seat, but if the cover part 100 is closed by the user after he or she has completed the urination or defecation, the seat part 200 starts to be cleaned, while the cleaning liquid is being prevented from leaking to the outside by means of the drain part 300. During the user's urination or defecation, as a result, the user does not recognize the existence of the drain part 300 or the user's legs are prevented from coming into contact with the drain part 300, thereby remarkably suppressing the possibility of occurrence of his or her unpleasant feeling.

### INDUSTRIAL APPLICABILITY

The toilet seat cleaning apparatus according to the embodiment of the present invention is applied to an industrial field for manufacturing toilet products such as toilets, toilet seats, bidets, and the like, an industrial field for managing the toilet products, and an industrial field for lending the toilet products, so that it is usefully utilized in such industrial fields.

1. A toilet seat cleaning apparatus comprising:
a seat part having a lower seat facing top of a ceramic toilet bowl and an upper seat with which a user's lower body comes into contact;
a cover part for covering or opening the upper seat of the seat part;
a drain part provided under the seat part and inducing a cleaning liquid flowing to the outside of the outer periphery of the seat part to flow to a discharge hole in the ceramic toilet bowl; and
a body part to which one side of the cover part is rotatably coupled,
wherein in a state where the cover part is opened, the other side of the seat part protrudes more forward than the other side of the drain part, and in a state where the cover part is closed, the other side of the drain part protrudes more forward than the other side of the seat part.

2. The toilet seat cleaning apparatus according to claim 1, wherein one side of the seat part is coupled to the body part, whereby if the other side of the cover part moves up, the seat part moves forward to allow the other side thereof to protrude more forward than the other side of the drain part, and if the other side of the cover part moves down, the seat part moves backward to allow the other side of the drain part to protrude more forward than the other side of the seat part.

3. The toilet seat cleaning apparatus according to claim 1, wherein the drain part comprises a first unit and a second unit, whereby if the other side of the cover part moves up, a distance between the first unit and the second unit becomes narrow, and if the other side of the cover part moves down, the distance between the first unit and the second unit becomes wide.

4. The toilet seat cleaning apparatus according to claim 2, wherein the drain part comprises a first unit and a second unit, whereby if the seat part moves forward, a distance between the first unit and the second unit becomes narrow, and if the seat part moves backward, the distance between the first unit and the second unit becomes wide.

5. The toilet seat cleaning apparatus according to claim 2, further comprising:
first connectors coupled to the body part in such a way as to be rotatable around a first rotary shaft, while being coupled to one side of the cover part; and second connectors coupled to the body part in such a way as to be movable forward or backward on the body part, while being coupled to one side of the seat part, wherein if the other side of the cover part moves up, the first connectors rotate in a first direction to allow a first protrusion of each first connector to push the corresponding second connector forward, and if the other side of the cover part moves down, the first connectors rotate in a second direction to allow a second protrusion of each first connector to pull the corresponding second connector backward.

6. The toilet seat cleaning apparatus according to claim 4, wherein the drain part further comprises:
a first guide wing located on the first unit; and
a first converter to which the first guide wing is slidably coupled,
whereby in a state where the first converter is coupled to the underside of the seat part, if the seat part moves forward, the first converter moves forward to allow the first unit to move in a direction close to the second unit, and if the seat part moves backward, the first converter moves backward to allow the first unit to move in a direction distant from the second unit.

7. The toilet seat cleaning apparatus according to claim 6, wherein the drain part further comprises:
a second guide wing located on the second unit; and
a second converter to which the second guide wing is slidably coupled,
whereby in a state where the second converter is coupled to the underside of the seat part, if the seat part moves forward, the second converter moves forward to allow the second unit to move in a direction close to the first unit, and if the seat part moves backward, the second converter moves backward to allow the second unit to move in a direction distant from the first unit.

8. The toilet seat cleaning apparatus according to claim 7, wherein the drain part further comprises:
a first shaft pin located on one end of the first unit; and
a second shaft pin located on one end of the second unit, the first shaft pin and the second shaft pip being rotatably coupled to each other,
whereby if the seat part moves forward, the first unit and the second unit rotate in a direction where a distance between the first guide wing and the second guide wing becomes narrow, and if the seat part moves backward, the first unit and the second unit rotate in a direction where the distance between the first guide wing and the second guide wing becomes wide.

9. The toilet seat cleaning apparatus according to claim 1, further comprising a cleaning liquid spray module and a wiper located disposed between the cover part and the seat part, the cleaning liquid spray module being adapted to spray the cleaning liquid on the upper seat of the seat part and the wiper being adapted to move in a state of being brought into contact with the upper seat of the seat part to remove the cleaning liquid remaining on the surface of the seat part.

10. The toilet seat cleaning apparatus according to claim 9, wherein the seat part comprises connecting arms located on the rear side thereof, one side of each connecting arm being coupled to the body part and the other side thereof being coupled to the seat part, whereby top of each connecting arm is lower than the upper seat of the seat part on a portion where the other side of the connecting arm is connected to the seat part so that a step is formed therebetween, and the wiper passes through top of each connecting arm, while coming into contact with at least a portion of the outer surface of the seat part.
